(19) United States
(12) Patent Application Publication
(10) Pub. No.: US 2011/0165857 A1
(43) Pub. Date: Jul. 7, 2011

(54) Managing presence information in a communications system

(75) Inventors: Antti Pihlajamäki, Helsinki (FI); Sami Ala-Luukko, Helsinki (FI)

(73) Assignee: TeliaSonera AB, Stockholm (SE)

(21) Appl. No.: 12/928,483

(22) Filed: Dec. 13, 2010

(30) Foreign Application Priority Data
Dec. 14, 2009 (EP) 09179040.2

(51) Int. Cl. H04M 11/00

(52) U.S. Cl. 455/405; 455/403

(57) ABSTRACT

The present solution relates to a method for providing an enhanced communication service in a communications system. In the method, if it is detected in a network apparatus (that presence data received from a user terminal comprises modified presence information related to the user terminal, the method comprises analysing the type of the modification. If it is detected that the presence data comprises a predetermined type of modified presence information, the method comprises indicating that the presence data received from the user terminal comprises value-added presence information related to the user terminal.

### BACKGROUND OF THE INVENTION

1. Field of the Invention

The present solution relates to managing presence information related to a user terminal.

2. Description of the Related Art

A rich communication suite (RCS) initiative is an effort of a group of telecommunications operators and vendors to enhance the adoption of enhanced mobile applications and services, providing an interoperable, convergent, rich communication experience. A presence service is an integral part of most multimedia services, basically showing the user's availability and/or willingness for communication. Regarding a presence data model, a rich communication suite (RCS) document (i.e. a presence document) may be used for presence exchange.

One of the disadvantages associated with the above arrangement is that is that in current systems presence information can only be charged based on transmitted data volume, the number of messages, etc. This type of charging does not necessarily reflect the user experienced value, i.e. it is really not service-based.

### SUMMARY OF THE INVENTION

An object of the present invention is thus to provide a method, system and a network apparatus for implementing the method so as to alleviate the above disadvantage. Objects of the invention are achieved by a method and an arrangement which are characterized by what is stated in the independent claims. Preferred embodiments of the invention are disclosed in the dependent claims.

The present solution is based on the idea of that, if it is detected in a network apparatus that presence data received from a user terminal comprises modified presence information related to the user terminal, the method comprises analysing the type of the modification. If it is detected based on the analysis that the presence data comprises a predetermined type of modified presence information, the method comprises indicating that the presence data received from the user terminal comprises value-added presence information related to the user terminal.

An advantage of the method and arrangement of the invention is that an optimized charging of the user for presence attributes related to the user terminal may be achieved.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following the invention will be described in greater detail by means of preferred embodiments with reference to the attached drawings, in which:

FIG. 1 illustrates a communications system according to a first exemplary embodiment;

FIG. 2 illustrates a communications system according to a second exemplary embodiment;

FIG. 3 is a signalling chart illustrating a method according to a first exemplary embodiment;

FIG. 4 is a signalling chart illustrating a method according to a second exemplary embodiment; and

FIG. 5 is a flow chart illustrating the functioning of a network apparatus according to an exemplary embodiment.

### DETAILED DESCRIPTION OF THE PRESENTLY PREFERRED EMBODIMENTS

The rich communication suite (RCS) is focused on the use of IMS (IP multimedia subsystem) for providing mobile phone communication services. Rich communication enables the use of more than just voice for communication. From the end-user point of view, RCS enables communication such as instant messaging, video sharing and/or buddy lists. These capabilities are available on any type of user devices using open communication between devices and networks. RCS may involve features such as an enhanced phonebook with service capabilities and presence enhanced contacts information, enhanced messaging which enables a large variety of messaging options including chat and messaging history, enriched call which enables multimedia content sharing during a voice call, and/or a “see what I see” capability. Wider and large scale IMS deployment, interoperability between different terminal vendor RCS clients, and RCS service interworking between operators are a part of RCS initiative. RCS leverages existing standards, taking on board different services defined by e.g. 3GPP and OMA and combines them with the enhanced phonebook. This allows the service capabilities as well as presence information of the different recipients to be shown in the terminal phonebook application. RCS reuses the capabilities of 3GPP specified IMS (IP multimedia subsystem) core system as the underlying service platform taking care of issues such as authentication, authorization, registration, charging and routing. The following services may be included in the RCS concept: presence, voice call, IM (instant messaging), video share, image share, SMS (short message service), MMS (multimedia messaging service). Some of the capabilities of RCS are also available from Internet service providers. Therefore, the present solution is not limited to the rich communication environment. Instead the present solution is applicable in any type of enhanced communication system. E.g. multimedia messaging service refers to a messaging service for sending and receiving multimedia messages. MMS combines conventional text messages with other (“richer”) content types, such as photographs, images, voice clips, and video clips. MMS is used with multimedia terminals, e.g. WAP (wireless application protocol) clients, which can receive and process multimedia messages.

A presence service/enabler represents an integral part of most multimedia services, basically showing the user's availability and/or willingness for communication. A rich communication suite (RCS) is one example of a service utilizing presence. Presence has evolved quite a lot recently and may contain a plenty of information on the user, other than just the availability/willingness of the user. The present solution enables a network operator and/or a service operator to charge for presence information based on user-experienced value, instead of just for generic presence information.

Regarding a presence data model, an exemplary rich communication suite (RCS) document (i.e. an exemplary presence document) used for presence exchange may be as follows:

```
<?xml version=”1.0” encoding=”UTF-8”?>
<presence xmlns:op=”urn:ietf:params:xml:ns:pidf”
xmlns:op=”urn:oma:xml:pde:pidf:oma-pres”
xmlns:opd=”urn:oma:xml:pde:pidf:ext”
xmlns:c=”urn:ietf:params:xml:ns:pidf:cipid”
entity=sip+1234578901@operator.com;user=phone>
<tuple id=”a1”>
  <status><basic>open</basic></status>
  <op:service-description>
```

| | |
|---|---|
| <op:service-id>org.3gpp.cs-videotelephony</op:service-id> | *x)* |

```
    <op:version>1.0</op:version>
  <op:service-description>
  <contact>tel:+358405344455</contact>
</tuple>
<tuple id=”a12”>
  <status><basic>open</basic></status>
  <op:service-description>
    <op:service-id>org.gsma.videoshare</op:service-id>
    <op:version>1.0</op:version>
  <op:service-description>
  <contact>sip+1234578901@operator.com;user=phone>
</tuple>
<tuple id=”a123”>
  <status><basic>open</basic></status>
  <op:service-description>
    <op:service-id>org.openmobilealliance:IM-session</op:service-id>
    <op:version>1.0</op:version>
  <op:service-description>
  <contact>sip:+1234578901@operator.com;user=phone</contact>
</tuple>
<pdm:person id=”a1233”>
  <op:overriding-willingness opd:until=”2008-10-28T21:00:00Z”>
      <op:basic>open</op:basic>
```

| | |
|---|---|
| </op:overriding-willingness> | *y)* |
| <c:homepage>http://example.com/~alice</c:homepage> | |
| <pdm:note>I'll be PAG</pdm:note> | |
| </pdm:person> | |
| </presence> | |

In the above example, it can be seen that a presence document may comprise information on multiple points; such as in point “x”, a service is identified as possible to the other party (watcher). In point “y” it is possible to deliver information on the user's favourite website, deliver a short free text notation, or state that the user is hyper-available. According to the present solution, this type of information is part of the added value in a presence service and outside of “normal” presence exchange, and could thus be charged accordingly (i.e. more) by the operator. For example, the exchange of free text in <pdm:note>I'll be PAG</pdm:note> has certain SMS-like characteristics. When the presence status is updated the complete RCS presence document is sent every time regardless of how much of the information has actually changed.

The present solution may be implemented in an interconnecting network (such as IPX) or within a sending/terminating operator's network. The present solution may be used to analyze presence data in more detail than previously possible. The idea is to analyze each presence update and compare it with the previous one. That way changes made by the users may be tracked in more detail, and, for example, free text or a favourite link may be charged separately. The present solution also makes it possible to differentiate status updates (online/busy/offline) from other presence data which may also be considered to be a means for communication.

In an exemplary embodiment of the present solution, a “free text” presence attribute is used as an example of presence data that resembles SMS and may thus be charged differently compared to generic presence data.

The field/purpose of the present solution is related to multimedia services and especially to presence. Usage and purpose of the present solution is to enable/optimize charging aspects related to using presence in inter-working networks, i.e. in interconnecting operator networks.

A problem that may be solved by using the present solution is that in current systems presence information can only be charged based on data volume, the number of messages, etc. This type of charging does not reflect the user experienced value, i.e. it is really not service-based. The present solution solves the problem by analyzing and comparing which kind of information has been changed in the presence information, and may thus be used to apply charging based on the value experienced by the user.

The present solution enables performing deeper analysis of presence information. Therefore, there may be extra requirements for the processing capabilities of the network components. Interworking agreements between operators may have to be more detailed in order to benefit from the present solution.

The best mode to implement the present solution is to carry out the implementation of the present solution in the interconnecting network (hubbing model) or in the sending/receiving operator's network.

Exemplary embodiments of the present solution will now be described more fully hereinafter with reference to the accompanying drawings, in which some, but not all embodiments of the solution are shown. Indeed, the solution may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

The present solution is applicable to any user terminal, server, corresponding component, and/or to any communication system or any combination of different communication systems that support services utilizing presence. The communication system may be a fixed communication system or a wireless communication system or a communication system utilizing both fixed networks and wireless networks. The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, the embodiment.

In the following, different embodiments will be described using as an example of a system architecture whereto the embodiments may be applied, an architecture based on an evolved UMTS terrestrial radio access network of an enhanced cellular network (E-UTRAN). Although E-UTRAN is discussed as a primary example herein, the present solution is not limited to E-UTRAN, LTE, and/or 3GPP systems. Thus, the present solution may also be applicable to other communications systems such as WiMAX (worldwide interoperability for microwave access), HSDPA (high-speed downlink packet access), HSUPA (high-speed uplink packet access), and/or WLAN (wireless local area network).

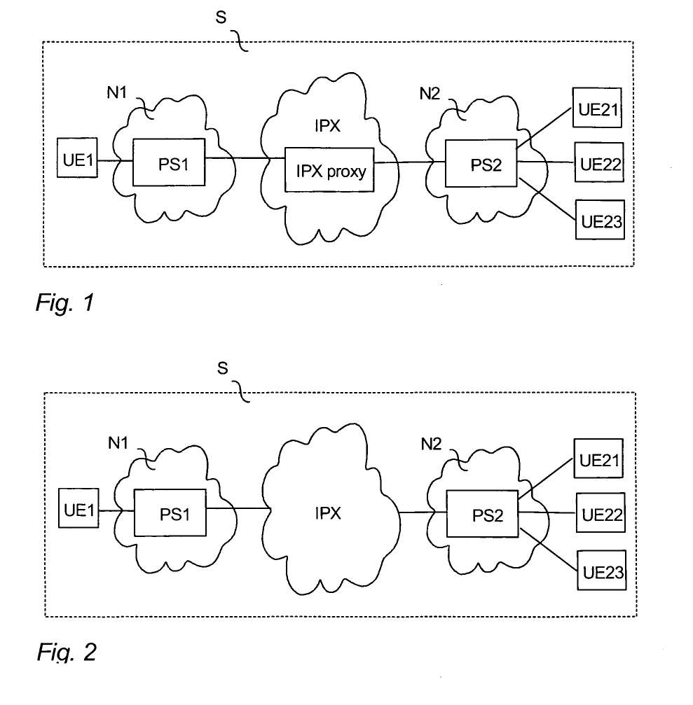

A general architecture of a communication system according to exemplary embodiments of the present solution is illustrated in FIGS. 1 and 2. FIGS. 1 and 2 are simplified system architectures only showing some elements and functional entities, all being logical units whose implementation may differ from what is shown. The connections shown in FIGS. 1 and 2 are logical connections; the actual physical connections may be different. It is apparent to a person skilled in the art that the systems also comprise other functions and structures. It should be appreciated that the functions, structures, elements and the protocols used in or for group communication, are irrelevant to the actual invention. Therefore, they need not to be discussed in more detail here.

FIG. 1 provides an example of an environment where the present solution may be used. Referring to FIG. 1, a communications system S according to a first exemplary embodiment of the present solution comprises a user equipment UE1, UE21, UE22, UE23 that may be e.g. a mobile or wireless user terminal, such as a mobile phone (mobile station), a personal digital assistant (PDA), a game console, a smart phone, a personal computer (PC), a laptop, a desktop computer or the like, capable of providing presence data. The system S further comprises a core network element PS1, PS2, IPX proxy, such as presence server or an IPX proxy server or any other core network element capable of handling presence data. The presence server PS1 of a first operator network N1 is operatively connected to the presence server PS2 of a second operator network N2 via the IPX proxy server of an interconnecting network IPX. In the example shown in FIG. 1, the first user terminal UE1 belongs to a first user and is capable of connecting to the first operator network N1, and the second user terminal UE21, UE22, UE23 (“watcher”) belongs to a second user and is capable of connecting to the second operator network N2.

FIG. 2 provides another example of an environment where the present solution may be used. Referring to FIG. 2, a communications system S according to a second exemplary embodiment of the present solution comprises a user equipment UE1, UE21, UE22, UE23 that may be e.g. a mobile or wireless user terminal, such as a mobile phone (mobile station), a personal digital assistant (PDA), a game console, a smart phone, a personal computer (PC), a laptop, a desktop computer or the like, capable of providing presence data. The system S further comprises a core network element PS1, PS2, such as presence server or any other core network element capable of handling presence data. The presence server PS1 of a first operator network N1 is operatively connected to the presence server PS2 of a second operator network N2 via an interconnecting network IPX. In the example shown in FIG. 1, the user terminal UE1 belongs to a first user and is capable of connecting to the first operator network N1, and the user terminal UE21, UE22, UE23 belongs to a second user and is capable of connecting to the second operator network N2.

FIGS. 1 and 2 show a simplified version of an evolved UMTS (universal mobile telecommunications system) terrestrial radio access network structure, which only illustrates the components that are essential to illustrate the present solution, even though those skilled in the art naturally know that a general communications system also comprises other functions and structures, which do not have to be described in more detail herein. The network element PS1, PS2, IPX proxy may include any network element operated by a network operator in a cellular, wireless and/or fixed network, such as a mobile switching centre, SGSN, GGSN, VLR, HLR, HSS, base station, access point, radio network controller, database, and/or a network computer or server. Although each network element UE1, PS1, N1, IPX, IPX proxy, PS2, N2, UE21, UE22, UE23 has been depicted as one entity, different modules and memory may be implemented in one or more physical or logical entities. A general architecture of a communication system providing presence-based communication is illustrated in FIGS. 1 and 2. FIGS. 1 and 2 are simplified system architectures only showing some elements and functional entities, all being logical units whose implementation may differ from what is shown. The connections shown in FIGS. 1 and 2 are logical connections; the actual physical connections may be different. It is apparent to a person skilled in the art that the systems also comprise other functions and structures. It should be appreciated that the functions, structures, elements and the protocols used in or for session-based communication are irrelevant to the actual invention. Therefore, they need not be discussed in more detail here.

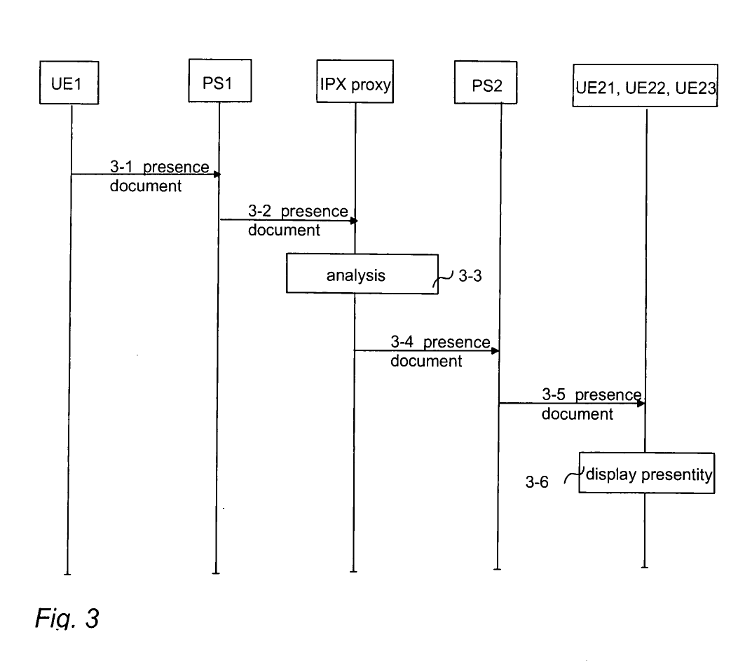

FIG. 3 illustrates signalling between network elements according to a first exemplary embodiment of the present solution. Referring to FIG. 3, a first user terminal UE1 provides presence information related to the first user terminal by transmitting a presence document in a message 3-1, 3-2 via a first presence server PS1 of a first operator network N1 to an IPX proxy server IPX proxy. The presence document may include (generic) presence information related to the first user terminal UE1 of a first user. The presence document may also include a free text presence attribute (e.g. “Dinner today, anyone?”) added by the first user to an appropriate free text field. In step 3-3, the presence document is received in IPX proxy. Further, in step 3-3, IPX proxy checks the presence document, and determines, on the basis of the presence information, whether or not the presence document comprises modified presence information related to the first user terminal UE1. If IPX proxy detects 3-3 that the presence document comprises modified presence information related to the first user terminal UE1, IPX proxy is configured to analyse 3-3 the type of the modification. The analysing may be carried out e.g. by comparing the received presence information related to the first user terminal UE1, with previously stored presence information related to the first user terminal UE1. If it is detected based on the analysis of step 3-3 that the presence document comprises a predetermined type of modified presence information (e.g. the presence data comprises a user-added free text presence attribute related to the first user terminal UE1, and/or the presence information has been updated at least a predetermined number of times within a predetermined time period (for example, more than three times per day)), IPX proxy is configured to indicate 3-3 that the presence data received from the first user terminal UE1 comprises value-added presence information related to the first user terminal UE1. The indicating may comprise e.g. storing information on the value-added presence information related to the first user terminal UE1, and/or transmitting (not shown in FIG. 1) information on the value-added presence information related to the first user terminal UE1 to a further network apparatus (e.g. an operator charging function) for value-added user charging purposes according to the present solution. In a message 3-4, 3-5 the presence document is transmitted from IPX proxy via a second presence server PS2 of a second operator network N2 to a second user terminal UE21, UE22, UE23. In step 3-6 the presence document is received in the second user terminal UE21, UE22, UE23, wherein the presentity of the first user terminal (or the first user) may be displayed 3-6 by the second user terminal UE21, UE22, UE23 to the user of the second user terminal UE21, UE22, UE23.

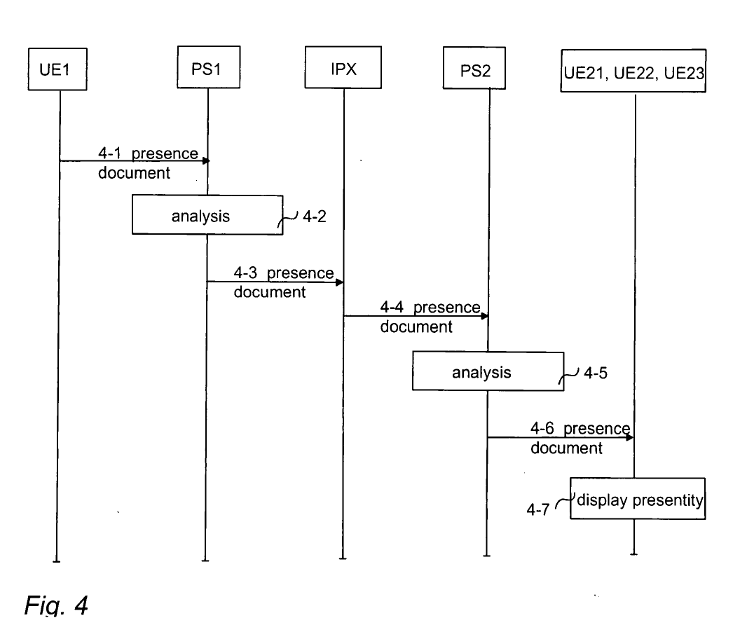

FIG. 4 illustrates signalling between network elements according to a second exemplary embodiment of the present solution. Referring to FIG. 4, a first user terminal UE1 provides presence information related to the first user terminal by transmitting a presence document in a message 4-1 to a first presence server PS1 of a first operator network N1. The presence document may include (generic) presence information related to the first user terminal UE1 of a first user. The presence document may also include a free text presence attribute (e.g. “Dinner today, anyone?”) added by the first user to an appropriate free text field. In step 4-2, the presence document is received in PS1. Further, in step 4-2, PS1 checks the presence document, and determines, on the basis of the presence information, whether or not the presence document comprises modified presence information related to the first user terminal UE1. If PS1 detects 4-2 that the presence document comprises modified presence information related to the first user terminal UE1, PS1 is configured to analyse 4-2 the type of the modification. The analysing may be carried out e.g. by comparing the received presence information related to the first user terminal UE1, with previously stored presence information related to the first user terminal UE1. If it is detected based on the analysis of step 4-2 that the presence document comprises a predetermined type of modified presence information (e.g. the presence data comprises a user-added free text presence attribute related to the first user terminal UE1, and/or the presence information has been updated at least a predetermined number of times within a predetermined time period (more than three times per day)), IPX proxy is configured to indicate 4-2 that the presence data received from the first user terminal UE1 comprises value-added presence information related to the first user terminal UE1. The indicating may comprise e.g. storing information on the value-added presence information related to the first user terminal UE1, and/or transmitting (not shown in FIG. 2) information on the value-added presence information related to the first user terminal UE1 to a further network apparatus (e.g. an operator charging function) for value-added user charging purposes according to the present solution. In a message 4-3, 4-4, 4-6 the presence document is transmitted via IPX proxy and a second presence server PS2 of a second operator network N2 to a second user terminal UE21, UE22, UE23. In step 4-7 the presence document is received in the second user terminal UE21, UE22, UE23, wherein the presentity of the first user terminal (or the first user) may be displayed 4-7 by the second user terminal UE21, UE22, UE23 to the user of the second user terminal UE21, UE22, UE23.

Another option is that the checking/analysing/storing/transmitting step as described above in step 4-2 is instead performed in step 4-5 in the second presence server PS2 of the second operator network N2. Yet another option is that the checking/analysing/storing/transmitting step as described above in step 4-2 is performed both in step 4-2 in the first presence server PS1 of the first operator network N1 and in step 4-5 in the second presence server PS2 of the second operator network N2.

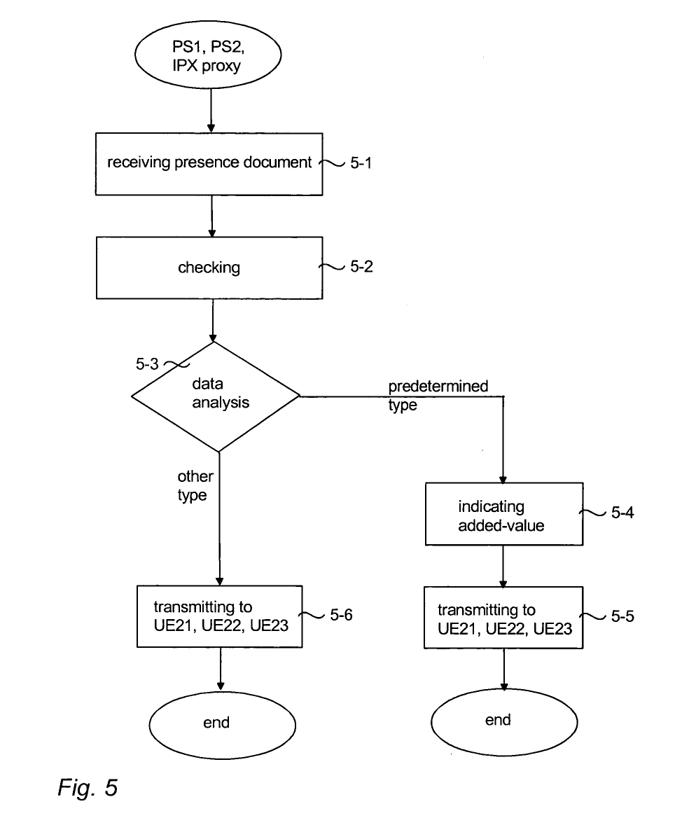

FIG. 5 illustrates the operation of a network apparatus according to an exemplary embodiment of the present solution. Referring to FIG. 5, the network apparatus (which may be e.g. an IPX proxy server IPX server of an interconnecting network IPX, a first presence server PS1 of a first network N1 where the first user terminal UE1 is located, and/or a second presence server (PS2 of a second network N2 where a second (“watcher”) user terminal UE22, UE23, UE24 is located) receives 5-1 a presence document from a first user terminal UE1 that e.g. wishes the first user's presence information to be available to a second user terminal UE22, UE23, UE24. The presence document may include (generic) presence information related to the first user terminal UE. The presence document may also include a free text presence attribute (e.g. “Dinner today, anyone?”) added by the first user to an appropriate free text field. In step 5-2, the network apparatus PS1, IPX server, PS2 checks the presence document, and determines, on the basis of the presence information, whether or not the presence document comprises modified presence information related to the first user terminal UE1. If IPX proxy detects 5-2 that the presence document comprises modified presence information related to the first user terminal UE1, the network apparatus is configured to analyse 5-3 the type of the modification. The analysing may be carried out e.g. by comparing the received presence information related to the first user terminal UE1, with previously stored presence information related to the first user terminal UE1. If it is detected based on the analysis of step 5-3 that the presence document comprises a predetermined type of modified presence information (e.g. the presence data comprises a user-added free text presence attribute related to the first user terminal UE1, and/or the presence information has been updated at least a predetermined number of times within a predetermined time period (e.g. more than three times per day)), the network apparatus is configured to indicate 5-4 that the presence data received from the first user terminal UE1 comprises value-added presence information related to the first user terminal UE1. The indicating may comprise e.g. storing information on the value-added presence information related to the first user terminal UE1, and/or transmitting 5-4 information on the value-added presence information related to the first user terminal UE1 to a further network apparatus (e.g. an operator charging function) for value-added user charging purposes according to the present solution. In step 5-5 the presence document is transmitted from network apparatus towards a second user terminal UE21, UE22, UE23. If it is detected based on the analysis of step 5-3 that the presence document only comprises other than a predetermined type of modified presence information (e.g. the presence data does not comprise a user-added free text presence attribute related to the first user terminal UE1, and/or the presence information has not been updated at least a predetermined number of times within a predetermined time period (e.g. more than three times per day)), the network apparatus is configured to transmit 5-6 the presence document towards a second user terminal UE21, UE22, UE23.

The steps/points, signaling messages and related functions described above in FIGS. 1 to 5 are in no absolute chronological order, and some of the steps/points may be performed simultaneously or in an order differing from the given one. Other functions can also be executed between the steps/points or within the steps/points and other signaling messages sent between the illustrated messages. Some of the steps/points or part of the steps/points can also be left out or replaced by a corresponding step/point or part of the step/point. The operations to be executed illustrate a procedure that may be implemented in one or more physical or logical entities. The signaling messages are only exemplary and may even comprise several separate messages for transmitting the same information. In addition, the messages may also contain other information.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firmware or software, implementation can be through modules (e.g., procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

User terminal (user equipment) may refer to any user communication device. A term “user equipment” as used herein may refer to any device having a communication capability, such as a wireless mobile terminal, a PDA, a smart phone, a personal computer (PC), a laptop computer, a desktop computer, etc. For example, the wireless communication terminal may be an UMTS or GSM/EDGE smart mobile terminal. Thus, the application capabilities of the device according to various embodiments of the invention may include native applications available in the terminal, or subsequently installed applications. The network apparatus may be implemented in any network element, such as a server.

An apparatus capable of performing operation according to various embodiments of the present solution may refer to any communication entity, such as the network apparatus, database or the user terminal. The apparatus may generally include a processor, controller, or the like connected to or comprising a memory. The memory may include volatile and/or non-volatile memory and typically stores content, data, or the like. For example, the memory may store computer program code such as software applications or operating systems, information, data, content, or the like for a processor to perform steps associated with operation of the entity in accordance with embodiments of the present invention. Also, for example, the memory typically stores content transmitted from, or received by, the apparatus. Memory may be, for example, random access memory (RAM), a hard drive, or other fixed data memory or storage device. The processor may receive input from an input device and may display information on a display. The processor may also be connected to at least one communication interface or other means for transmitting and/or receiving data, content, messages, or the like. Where the apparatus provides wireless communication, such as in a UMTS, GSM, EDGE, WCDMA network, Bluetooth network, a wireless LAN network, or other mobile network, the processor may operate with a wireless communication subsystem of the interface. Where the apparatus provides an IP server with IP communication, the processor may operate with an IP communication system of the interface. One or more processors, memory, storage devices, and other computer elements may be used in common by a computer system and subsystems, as part of the same platform, or processors may be distributed between a computer system and subsystems, as parts of multiple platforms. If the apparatus is, for example, a mobile station or a network server, the apparatus may also include modules such as a messaging service client/server and/or an application associated with the processor. These modules may be software and/or software-hardware components. For example, a messaging service client/server may include software capable of establishing, modifying, and terminating messaging sessions, to send and receive messages, etc. The apparatus may generally include a processor, controller, control unit or the like connected to a memory and to various interfaces of the apparatus. Generally the processor is a central processing unit, but the processor may be an additional operation processor. The processor may comprise a computer processor, application-specific integrated circuit (ASIC), field-programmable gate array (FPGA), and/or other hardware components that have been programmed in such a way to carry out one or more functions of an embodiment. An interface provides a transmitter and/or a receiver or a corresponding means for receiving and/or transmitting data, content, messages including the above described advertisements, responses and solicitation messages.

At least some embodiments or aspects described herein may be implemented using programming stored within an appropriate storage circuitry described above or communicated via a network or other transmission media and configured to control appropriate processing circuitry. For example, programming may be provided via appropriate media including, for example, embodied within articles of manufacture, embodied within a data signal (e.g., modulated carrier wave, data packets, digital representations, etc.) communicated via an appropriate transmission medium, such as a communication network (e.g., the Internet or a private network), wired electrical connection, optical connection or electromagnetic energy, for example, via communications interface, or provided using other appropriate communication structure or medium. Exemplary programming including processor-usable code may be communicated as a data signal embodied in a carrier wave in but one example.

It will be obvious to a person skilled in the art that, as the technology advances, the inventive concept can be implemented in various ways. The invention and its embodiments are not limited to the examples described above but may vary within the scope of the claims.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A method for providing an enhanced communication service in a communications system, the system comprising a network apparatus capable of managing presence information related to a first user terminal, wherein, if it is detected, in the network apparatus, that presence data received from a first user terminal comprises modified presence information related to the first user terminal, the method comprises
analysing, in the network apparatus, the type of the modification, wherein, if it is detected that the presence data comprises a predetermined type of modified presence information, the method comprises
indicating, in the network apparatus, that the presence data received from the first user terminal comprises value-added presence information related to the first user terminal.

2. A method according to claim 1, wherein said analysing comprises checking whether the presence data comprises a user-added free text presence attribute related to the first user terminal, wherein, if it is detected that the presence data comprises a free text presence attribute related to the first user terminal, the method comprises
indicating that the presence data comprises value-added presence information related to the first user terminal.

3. A method according to claim 1, wherein said analysing comprises
checking whether the presence information related to the first user terminal has been updated at least a predetermined number of times within a predetermined time period, wherein, if it is detected that the presence information has been updated at least a predetermined number of times within a predetermined time period, the method comprises
indicating that the presence data comprises value-added presence information related to the first user terminal.

4. A method according to claim 1, wherein the analysing is carried out by comparing the received presence information related to the first user terminal, with previously stored presence information related to the first user terminal.

5. A method as claimed in claim 1, wherein said indicating comprises storing information on the value-added presence information related to the first user terminal for value-added user charging purposes.

6. A method as claimed in claim 1, wherein said indicating comprises transmitting information on the value-added presence information related to the first user terminal to a further network apparatus for value-added user charging purposes.

7. A method as claimed in claim 1, the method further comprising optimizing the charging of user by charging the user for transmitting presence information other than generic and/or non-updated presence information.

8. A method as claimed in claim 1, wherein the presence data comprises the presence status of the user of the first user terminal regarding multimedia messaging, sending photographs, sending images, voice clip, video clip, instant messaging, video sharing, buddy lists, enhanced phonebook, chat, messaging history, enriched call, and/or a see what I see capability.

9. A communications system comprising
a network apparatus capable of managing presence information related to a first user terminal, and detecting that presence data received from a first user terminal comprises modified presence information related to the first user terminal, wherein
the system is configured to
analyse, in response to said detecting by the network apparatus, the type of the modification, and
indicate, in response to detecting during analysing that the presence data comprises a predetermined type of modified presence information, that the presence data received from the first user terminal comprises value-added presence information related to the first user terminal.

10. A system according to claim 9, further configured to
check whether the presence data comprises a user-added free text presence attribute related to the first user terminal, and
indicate, in response to the presence data comprising a free text presence attribute related to the first user terminal, that the presence data comprises value-added presence information related to the first user terminal.

11. A system according to claim 9, further configured to
check whether the presence information related to the first user terminal has been updated at least a predetermined number of times within a predetermined time period, wherein, if it is detected, the system is configured to
indicate, in response to the presence information having been updated at least a predetermined number of times within a predetermined time period, that the presence data comprises value-added presence information related to the first user terminal.

12. A system as claimed in claim 9, further configured to store information on the value-added presence information related to the first user terminal for value-added user charging purposes.

13. A system as claimed in claim 9, further configured to transmit information on the value-added presence information related to the first user terminal to a further network apparatus for value-added user charging purposes.

14. A network apparatus capable of managing presence information related to a first user terminal, and detecting that presence data received from a first user terminal comprises modified presence information related to the first user terminal, the network apparatus comprising
at least one processor; and
at least one memory including computer program code;
the at least one memory and the computer program code configured to, with the at least one processor, cause the network apparatus at least to
analyse, in response to said detecting, the type of the modification, and
indicate, in response to detecting during analysing that the presence data comprises a predetermined type of modified presence information that the presence data received from the first user terminal comprises value-added presence information related to the first user terminal.

15. A network apparatus according to claim 14, wherein the at least one memory and the computer program code are configured to, with the at least one processor, further cause the network apparatus to check whether the presence data comprises a user-added free text presence attribute related to the first user terminal, and
indicate, in response to detecting during checking that the presence data comprises a free text presence attribute related to the first user terminal, that the presence data comprises value-added presence information related to the first user terminal.

16. A network apparatus according to claim 14, wherein the at least one memory and the computer program code are configured to, with the at least one processor, further cause the network apparatus, to
check whether the presence information related to the first user terminal has been updated at least a predetermined number of times within a predetermined time period, and
indicate, in response to the presence information having been updated at least a predetermined number of times within a predetermined time period, that the presence data comprises value-added presence information related to the first user terminal.

17. A network apparatus according to claim 14, wherein the at least one memory and the computer program code are configured to, with the at least one processor, further cause the network apparatus to carry out the analysing by comparing the received presence information related to the first user terminal, with previously stored presence information related to the first user terminal.

18. A network apparatus as claimed claim 14, wherein the at least one memory and the computer program code are configured to, with the at least one processor, further cause the network apparatus to store information on the value-added presence information related to the first user terminal for value-added user charging purposes.

19. A network apparatus as claimed in claim 14, wherein the at least one memory and the computer program code are configured to, with the at least one processor, further cause the network apparatus to transmit information on the value-added presence information related to the first user terminal to a further network apparatus for value-added user charging purposes.

20. A network apparatus as claimed in claim 14, wherein the at least one memory and the computer program code are configured to, with the at least one processor, further cause the network apparatus to optimize the charging of user by charging the user for transmitting presence information other than generic and/or non-updated presence information.

21. A network apparatus as claimed in claim 14, further comprising an IPX proxy server of an interconnecting network, a first presence server of a first network where the first user terminal is located, and/or a second presence server of a second network where a watcher user terminal is located.
